(19) United States
(12) Patent Application Publication
(10) Pub. No.: US 2010/0064056 A1
(43) Pub. Date: Mar. 11, 2010

(54) COMMUNICATION SYSTEM AND METHOD

(75) Inventors: YA-YI PENG, Tu-Cheng (TW); HSING-CHANG LIU, Tu-Cheng (TW); SHU-CHI CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/272,800

(22) Filed: Nov. 18, 2008

(30) Foreign Application Priority Data
Sep. 8, 2008 (CN) 200810304415.2

(51) Int. Cl. G06F 15/16

(52) U.S. Cl. 709/236

(57) ABSTRACT

A communication system includes a computer terminal and a server. The computer terminal includes a command control module and a response detecting module. The server includes a response control module. The command control module is configured for sending a command to the server. The response control module is configured for receiving the command, calculating a command check reference value according to the received command using a first formula, and sending a response to the response detecting module. The response detecting module is configured for calculating a response check reference value according to the response using a second formula. If the response check reference value is not equal to the response checksum bits value, the command control module resends the command corresponding to the received command to the server.

### BACKGROUND

1. Technical Field

The present invention relates to communication systems and methods for communicating computer terminals with servers and, particularly, to a communication system and method for assuring both the computer terminal and the server receiving integrated communication information.

2. Description of Related Art

Computer terminals and servers are typically found in communication systems. A communication protocol must be established between a computer terminal and a server, before sending and receiving data. If communication protocols cannot determine if the received information is integrated, the computer terminal or the server may receive error communication information.

Therefore, it is desired to provide a communication system and method to overcome the above described shortcomings.

### BRIEF DESCRIPTION OF THE DRAWINGS

FIG. 1 is a block diagram of an embodiment of a communication system.

FIG. 2 is a flowchart of an embodiment of a communication method for implementing the communication system of FIG. 1.

### DETAILED DESCRIPTION

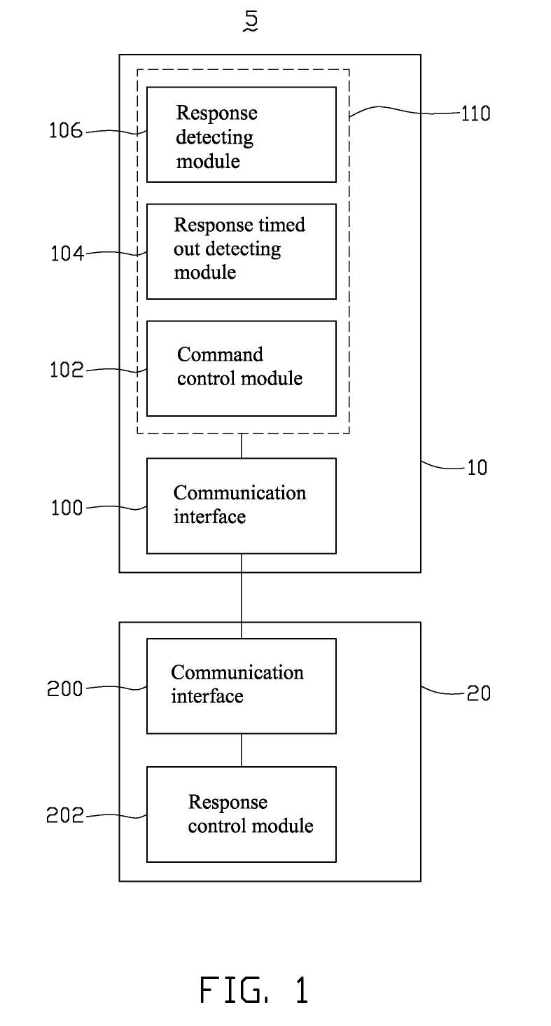

Referring to FIG. 1, an embodiment of a communication system 5 includes a computer terminal 10 and a server 20. The computer terminal 10 includes a communication interface 100 and a processing module 11 0. The processing module 110 includes a command control module 102, a response timed out detecting module 104, and a response detecting module 106. The server 20 includes a communication interface 200 and a response control module 202. The computer terminal 10 communicates with the server 20 by connecting the communication interface 100 to the communication interface 200.

The command control module 102 is configured for sending commands to the server 20 via the communication interface 100. In one example, each command includes command start bits, command type bits, command parameter bits, command end bits, and command checksum bits. The command start bits indicate a start of the command. The command type bits indicate types of the command. For example, if the computer terminal 10 sends a temperature control command to the server 20, the command type bits of the command may be set as “1” to indicate an increase temperature command type, and the command type bits may be set as “0” to indicate a decrease temperature command type. The command parameter bits indicate parameters of the command. For example, the command data “11111” indicates a 31 degree change of temperature. The command end bits indicate an end of the command. A value of the command checksum bits is calculated using a first formula. The first formula may be a sum of the command type bits and the command parameter bits. In one example, if a value of the command type bits is “1” and a value of the command parameter bits is “01010”, the value of the command checksum bits would be “01011”.

The response control module 202 is configured for receiving the commands sent from the computer terminal 10 via the communication interface 200, and for sending responses to the computer terminal 10. In one example, each response includes response start bits, response result bits, response verifying bits, response end bits, and response checksum bits. The response start bits indicate a start of the response. The response result bits indicate a content of the response corresponding to a received command. The response verifying bits indicate if the command has been successfully received. The response control module 202 is configured for calculating a command check reference value according to the received command using the first formula, and determines if the command check reference value is equal to the value of the command checksum bits. If the command check reference value is not equal to the value of the command checksum bits, a value of the response verifying bits may be set as “0”, indicating a data integrity error of the received command, the received command is discarded, and the computer terminal 10 resends the command corresponding to the received command to the server 20. If the command check reference value is equal to the value of the command checksum bits, a value of the response verifying bits may be set as “1”, indicating that the data integrity of the received command is valid. The command end bits indicate an end of the response. A value of the response checksum bits is calculated using a second formula. The second formula may be a sum of the response verifying bits and the response result bits.

The response detecting module 106 is configured for receiving a response sent from the communication interface 200, for calculating a response check reference value of the received response using a second formula, and for determining if the response check reference value is equal to the value of the response checksum bits. If the response check reference value is not equal to the value of the response checksum bits, a data integrity error of the received response is in error, the received response is discarded, and the server 20 resends a response to the computer terminal 10. If the response check reference value is equal to the value of the response checksum bits, the data integrity of the received response is valid. The response detecting module 106 further determines if the sent command is integrated by checking the response verifying bits. If the response verifying bits indicate the sent command is in error, the command control module 102 resends the command corresponding to the received command to the server 20. In one example, the value of the response verifying bits of “0”, indicates a data integrity error of the received command. Similarly, the value of the response verifying bits is “1”, indicates that the data integrity of the received command is valid.

The response timed out detecting module 104 is configured for setting a predetermined communication time to determine if the response detecting module 106 receives subsequent responses sent from the server 20 within the predetermined communication time. For example, if the response detecting module 106 receiving the response has timed out, the response will not received within the predetermined communication time, indicating a communicating error between the computer terminal 10 and the server 20. Accordingly, the command control module 102 resends the command corresponding to the received command to the server 20.

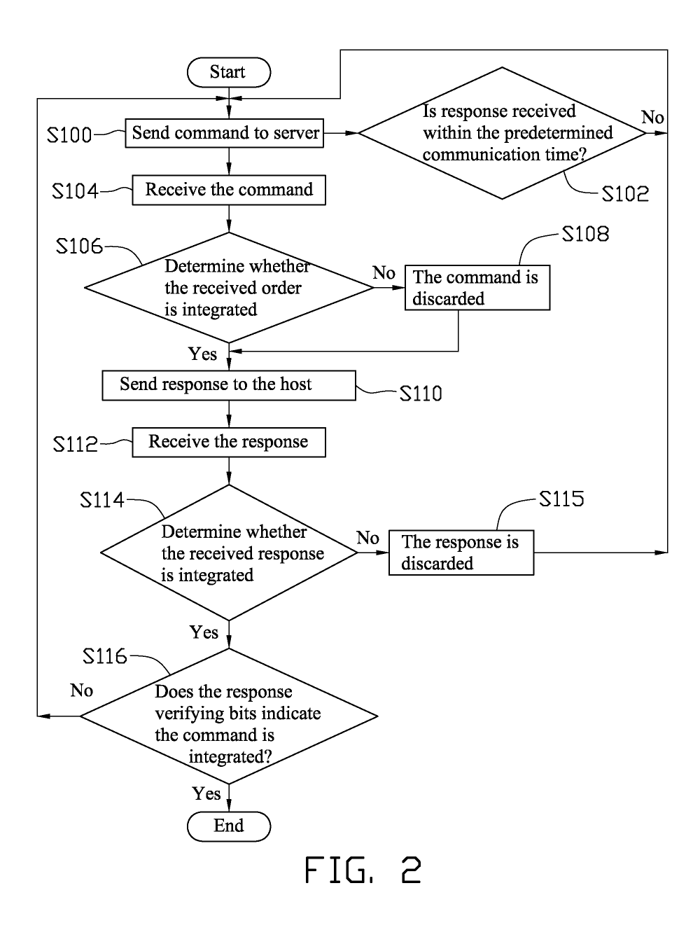

Referring to FIG. 2, an embodiment of a communication method for implementing the communication system of FIG. 1 includes the following steps described below.

In step S100, the command control module 102 of the computer terminal 10 sends a command to the server 20 via the communication interface 100.

In step S102, the response timed out detecting module 104 determines if the response detecting module 106 receives a subsequent response within the predetermined communication time. If the response detecting module 106 does not receive the response within the predetermined communication time, a communicating error between the computer terminal 10 and the server 20 is determined, and the method returns to step S100 described above.

In step S104, the response control module 202 of the server 20 receives the command via the communication interface 200.

In step S106, the response control module 202 calculates the command check reference value according to the received command using the first formula and determines if the command check reference value is equal to the value of the command checksum bits. If the command check reference value is not equal to the value of the command checksum bits, the data integrity of the received command is in error, and the method goes to step S108. If the command check reference value is equal to the value of the command checksum bits, the data integrity of the received command is valid, and the method goes to step S110.

In step S108, the value of the response verifying bits is set to indicate a data integrity error of the received command, for example “0”, the received command is to be discarded, and the method goes to step S110.

In step S110, the value of the response verifying bits is set to indicate that the data integrity of the received command is valid, for example “1”, and the response control module 202 sends the response to the computer terminal 10.

In step S112, the response detecting module 106 receives the response.

In step S114, the response detecting module 106 calculates the response check reference value according to the response using the second formula, and determines if the response check reference value is equal to the value of the response checksum bits. If the response check reference value is not equal to the value of the response checksum bits, the data integrity of the received response is in error, the received response is discarded, and the method goes to step S115. If the response check reference value is equal to the value of the response checksum bits, the data integrity of the received response is valid, and the method goes to step S116.

In step S115, the received command is discarded, and the method returns to the step S100 described above.

In step S116, the response detecting module 106 determines if the received command is integrated by checking the response verifying bits. If the response verifying bits indicate the data integrity error of the received command, the method returns to the step S100 described above. If the response verifying bits indicate the data integrity of the received command is valid, the method ends. In one example, a value of the response verifying bits may be “0”, indicating the data integrity error of the received command, and a value of the response verifying bits may be “1”, indicating that the data integrity of the received command is valid.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A communication system, comprising:
a computer terminal comprising a command control module and a response detecting module; and
a server comprising a response control module; wherein the command control module is configured for sending a command to the server; the response control module is configured for receiving the command and calculating a command check reference value using a first formula, determining if the command check reference value is equal to a command checksum bits value of the command, and sending a response to the response detecting module based on the compared result; the response detecting module is configured for calculating a response check reference value according to the response using a second formula; upon a condition that the response check reference value is not equal to a response checksum bits value of the received response, the command control module resends the command corresponding to the received command to the server.

2. The communication system of claim 1, wherein the command further comprises command start bits indicating a start of the command, command type bits indicating command types, command parameter bits indicating parameters of the command, and command end bits indicating an end of the command; the command checksum bits value is calculated using the first formula.

3. The communication system of claim 2, wherein the first formula is a sum of the command type bits and the command parameter bits.

4. The communication system of claim 1, wherein the response further comprises response start bits indicating that a start of the response, response result bits indicating contents of the response corresponding to the received command, response verifying bits indicating if the command has been successfully received, and response end bits indicating that an end of the response; the value of response checksum bits is calculated using the second formula.

5. The communication system of claim 4, wherein the second formula is a sum of the response verifying bits and the response result bits.

6. The communication system of claim 1, wherein the computer terminal further comprises a response timed out detecting module configured for setting a predetermined communication time to determine if the response detecting module receives the response within the predetermined communication time; upon a condition that the response detecting module receives the response within the predetermined communication time, the command control module resends the command corresponding to the received command to the server.

7. A communication method, comprising:
sending a command from a computer terminal to a server;
receiving the command;
calculating a command check reference value according to the received command using a first formula;
determining if the command check reference value is equal to a value of command checksum bits of the command;
upon a condition that the command check reference value is not equal to the value of the command checksum bits of the command, discarding the received command;
upon a condition that the command check reference value is equal to the value of the command checksum bits of the command, sending a response to the computer terminal;
calculating a response check reference value of the received response using a second formula;
determining if the response check reference value is equal to a value of response checksum bits of the received response;
upon a condition that the response check reference value is not equal to the value of the response checksum bits, discarding the received response, and resending a command corresponding to the received command to the server.

8. The communication method of claim 7, further comprising: upon a condition that the computer terminal does not receive the response within the predetermined communication time, indicating a communicating error between the computer terminal and the server, and resending the command corresponding to the received command to the server.

9. The communication method of claim 7, further comprising:
upon a condition that the response check reference value is equal to the value of the response checksum bits, determining if the command is integrated by checking the response verifying bits of the response;
upon a condition that the response verifying bits indicates the data integrity error of the command, resending the command corresponding to the received command to the server;
upon a condition that the command is integrated, ending the method.

10. A computer-readable medium having stored thereon instructions that, when executed by a computer, cause the computer to perform a method, the method comprising:
sending a command from a computer terminal to a server;
receiving the command;
calculating a command check reference value according to the received command using a first formula;
determining if the command check reference value is equal to a value of command checksum bits of the command;
upon a condition that the command check reference value is not equal to the value of the command checksum bits of the command, discarding the received command;
upon a condition that the command check reference value is equal to the value of the command checksum bits of the command, sending a response to the computer terminal;
calculating a response check reference value of the received response using a second formula;
determining if the response check reference value is equal to a value of response checksum bits of the received response;
upon a condition that the response check reference value is not equal to the value of the response checksum bits, discarding the received response, and resending a command corresponding to the received command to the server.

11. The communication method of claim 10, further comprising: upon a condition that the computer terminal does not receive the response within the predetermined communication time, indicating a communicating error between the computer terminal and the server, and resending the command corresponding to the received command to the server.

12. The communication method of claim 10, further comprising:
upon a condition that the response check reference value is equal to the value of the response checksum bits, determining if the command is integrated by checking the response verifying bits of the response;
upon a condition that the response verifying bits indicates the data integrity error of the command, resending the command corresponding to the received command to the server;
upon a condition that the command is integrated, ending the method.
